(19) United States
(12) Patent Application Publication
(10) Pub. No.: US 2025/0301233 A1
(43) Pub. Date: Sep. 25, 2025

(54) CAMERA WITH COMPRESSIVE SENSING

(71) Applicant: NVIDIA Corporation, Santa Clara, CA (US)

(72) Inventors: Ward Lopes, Redwood City, CA (US); David Patrick Luebke, Charlottesville, VA (US)

(21) Appl. No.: 19/084,565

(22) Filed: Mar. 19, 2025

Related U.S. Application Data
(60) Provisional application No. 63/567,345, filed on Mar. 19, 2024.

(51) Int. Cl. H04N 25/11; H04N 23/12; H04N 23/55; H04N 23/62

(52) U.S. Cl. CPC H04N 25/11; H04N 23/12; H04N 23/55; H04N 23/62

(57) ABSTRACT

Hyperspectral and multispectral cameras are unique from conventional cameras in that they are configured to capture and separate the light from a scene into its individual wavelengths or spectral bands. Conventional cameras, on the other hand, capture three-channel color information, i.e., the intensity of red, green and blue colors. Currently, hyperspectral/multispectral cameras are expensive scientific devices (i.e. not built from off the shelf components), thus limiting the availability to the general population. Furthermore, the currently available designs of hyperspectral/multispectral cameras tend to make trade-offs between three quantities: spectral resolution, spatial resolution, and the time to acquire an image, such that improving one area negatively impacts the others. The present disclosure provides a hyperspectral or multispectral type camera, which can be built from off the shelf components, and that is configured with compressive sensing, which can alleviate at least part of the three-way design tradeoff present in current hyperspectral camera designs.

### RELATED APPLICATION(S)

This application claims the benefit of U.S. Provisional Application No. 63/567,345 (Attorney Docket No. NVIDP1397+/24-SC-0271US01) titled “HYPERSPECTRAL CAMERA DESIGN UTILIZING COMPRESSIVE SENSING,” filed Mar. 19, 2024, the entire contents of which is incorporated herein by reference.

### TECHNICAL FIELD

The present disclosure relates to camera systems and methods.

### BACKGROUND

Hyperspectral and multispectral cameras are unique from conventional cameras in that they are configured to capture and separate the light from a scene into its individual wavelengths or spectral bands. Conventional cameras, on the other hand, more simply capture three-channel color information, i.e., the intensity of red, green and blue colors. Hyperspectral/multispectral cameras are, in part, beneficial in that they can provide hundreds of bands of spectral data and can more accurately identify the spectral characteristics of different scenes or substances.

Currently however, hyperspectral/multispectral cameras are expensive scientific devices (i.e. not built from off the shelf components), thus limiting the availability to the general population. Furthermore, the currently available designs of hyperspectral/multispectral cameras tend to make trade-offs between three quantities: spectral resolution, spatial resolution, and the time to acquire an image, such that improving one area negatively impacts the others.

There is thus a need for addressing these issues and/or other issues associated with the prior art. For example, there is a need for a hyperspectral or multispectral type camera, which can be built from off the shelf components, and that is configured with compressive sensing, which can alleviate at least part of the three-way design tradeoff present in current hyperspectral camera designs.

### SUMMARY

A camera system and method are provided. In an embodiment, the camera system includes a lens configured to capture light from a scene, a reconfigurable spectral filter configured to receive the light captured from the scene and to transmit two or more non-contiguous narrow spectral bandwidth signals, and a detector configured to receive the two or more non-contiguous narrow spectral bandwidth signals for detecting wavelengths of interest.

### BRIEF DESCRIPTION OF THE DRAWINGS

FIG. 1 illustrates a camera system, in accordance with an embodiment.

FIG. 2 illustrates a camera system with a color filter wheel, in accordance with an embodiment.

FIG. 3 illustrates a camera system with a dispersive optical element and a reconfigurable optical filter, in accordance with an embodiment.

FIG. 4 illustrates an optical filter, in accordance with an embodiment.

FIG. 5 illustrates a camera system with the optical filter of FIG. 4, in accordance with an embodiment.

FIG. 6 illustrates a camera system with a folded optical path including the optical filter of FIG. 4, in accordance with an embodiment.

FIG. 7 illustrates a method of operation of a hyperspectral camera system, in accordance with an embodiment.

FIG. 8 illustrates an exemplary computing system, in accordance with an embodiment.

### DETAILED DESCRIPTION

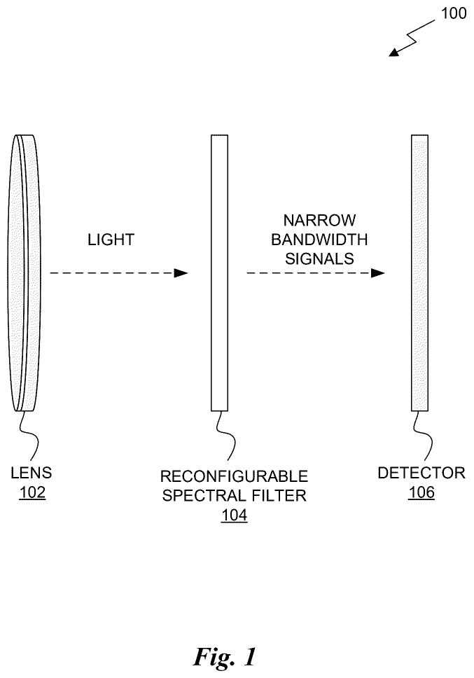

FIG. 1 illustrates a camera system 100, in accordance with an embodiment. In the context of the present description, the camera system 100 is a device configured to capture images of real-world scenes. In an embodiment, the camera system 100 may be a handheld device capable of being physically operated by a user. In another embodiment, the camera system 100 may be a device installed on another stationary device or non-stationary device (e.g. autonomous driving vehicle, robotic device, etc.) and capable of being remotely operated by a user or by an application.

As shown, the camera system 100 includes a lens 102, a reconfigurable spectral filter 104, and a detector 106. The illustrated components 102-106 of the camera system 100 may be enclosed in a same camera housing (not shown). Additional components of the camera system 100, such as those described in the remaining figures below, may also be enclosed in the camera housing, in an embodiment. As described herein, the illustrated components 102-106 of the camera system 100 may be situated in series with one another, in an embodiment without additional components therebetween (as shown) or in another embodiment optionally with one or more additional components therebetween. Each pair of components in series may be situated some defined distance from one another within the camera system 100.

In the present embodiment, the lens 102 refers to a component of the camera system 100 that is configured to capture light from a (e.g. real-world) scene. In an embodiment, the lens 102 may be comprised of a transparent material (e.g. glass). In an embodiment, at least a portion of a surface of the lens 102 may be curved for focusing the light from the scene.

The reconfigurable spectral filter 104 refers to a component of the camera system 100 that is configured to receive the light captured from the scene (i.e. by the lens 102) and to transmit two or more non-contiguous narrow spectral bandwidth signals. In an embodiment, the spectral filter 104 is configured to only transmit, from the light, the two or more non-contiguous narrow spectral bandwidth signals. In this way, the spectral filter 104 may operate to filter out (e.g. block, etc.), from the light, spectral bandwidth signals other than the two or more non-contiguous narrow spectral bandwidth signals.

With respect to the present description, a narrow spectral bandwidth signal refers to a signal comprised of one or more wavelengths of the light that are within a defined spectral band. As mentioned, the spectral filter 104 is configured to transmit two or more non-contiguous narrow spectral bandwidth signals, or in other words the wavelengths of the light that are within each of two or more defined spectral bands that not contiguous, within the spectrum of light, with respect to each other. In the present embodiment, “narrow” refers to a spectral band that spans up to a maximum number of wavelengths (e.g. that are continuous on the spectrum of light), where such maximum is less than all possible wavelengths. In an embodiment, a multispectral camera system may record the spectrum of a scene or object with fewer spectral band (e.g. at least 3 but less than 12 to 15) than a hyperspectral camera which may record the spectrum of a scene with a greater number of spectral band (e.g. tens of spectral bands or more). Usually, the spectral bands used with multispectral cameras have a wider bandwidth than the spectral bands used in hyperspectral cameras. Embodiments described herein may relate to hyperspectral and/or multispectral type camera systems.

As mentioned, the spectral filter 104 is reconfigurable, which refers to the capability to change which non-contiguous narrow spectral bandwidth signals are transmitted by the spectral filter 104. In an embodiment, the spectral filter 104 may be physically (e.g. manually) manipulated to change which non-contiguous narrow spectral bandwidth signals are transmitted by the spectral filter 104. In another embodiment, the spectral filter 104 may be electrically manipulated to change which non-contiguous narrow spectral bandwidth signals are transmitted by the spectral filter 104.

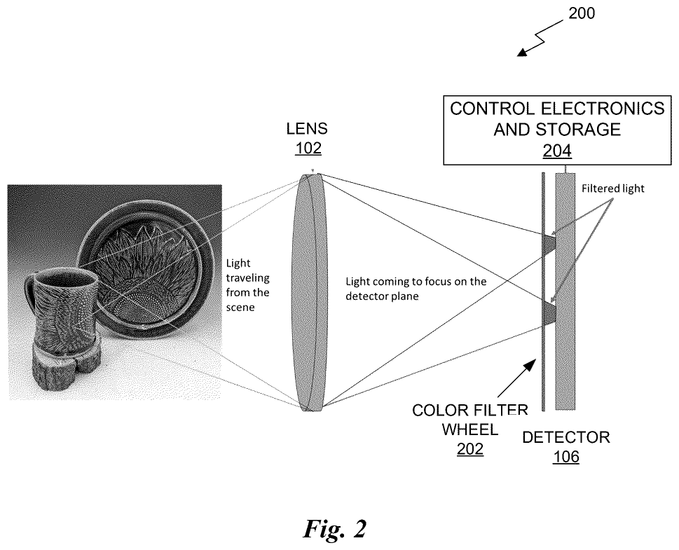

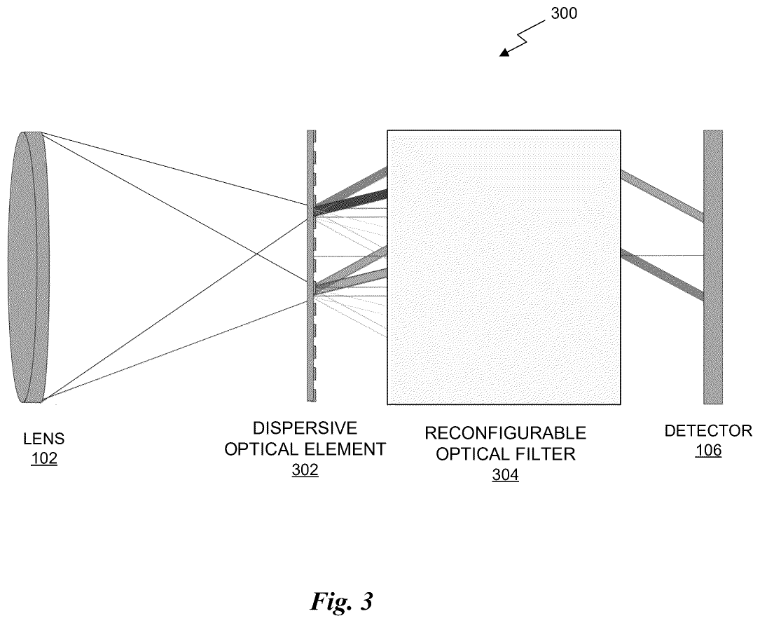

In an embodiment, the spectral filter 104 may include a color filter wheel comprised of a plurality of filters each configured to transmit wavelengths for one or more different spectral bands. One implementation of this configuration of the spectral filter 104 will be described below with respect to FIG. 2. In another embodiment, the spectral filter 104 may include a dispersive optical element configured to change a direction in which the light captured from the scene travels based on its wavelength or frequency, and a reconfigurable optical filter configured to select wavelengths transmitted based on the changed direction of the light. One implementation of this configuration of the spectral filter 104 will be described below with respect to FIG. 3.

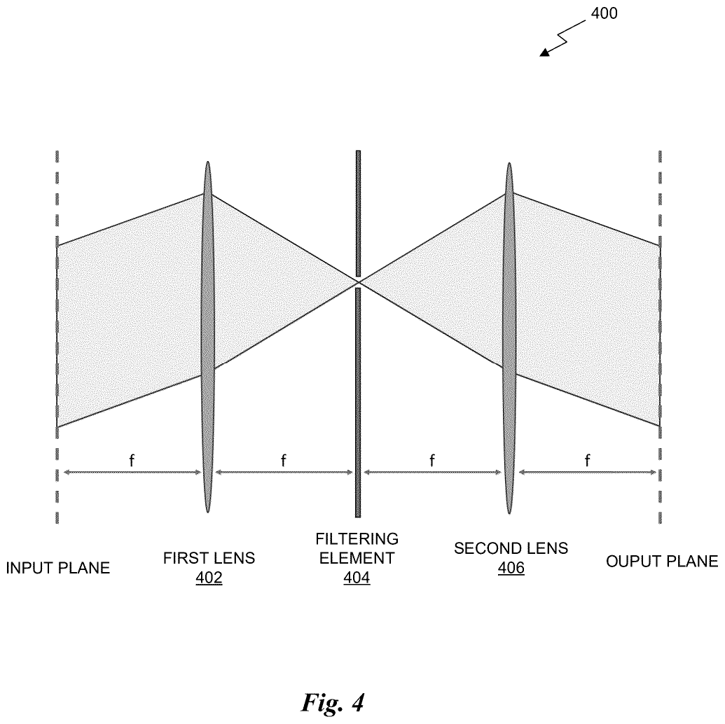

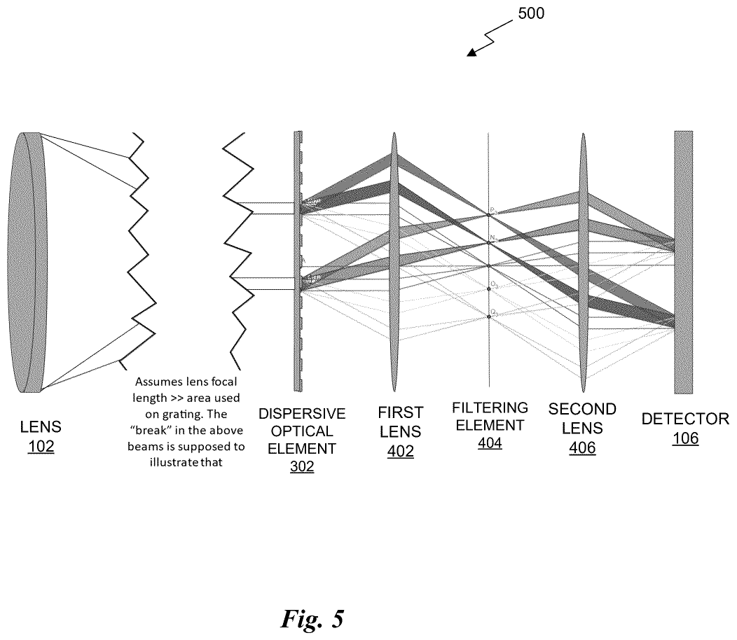

In an embodiment, the dispersive optical element may be a diffractive optical element, such as a diffraction grating or a holographic element. In an embodiment, the optical filter may be a rotating filter. In another embodiment, the optical filter may be a spatial optical filter consisting of at least: an input plane at a location of the dispersive optical element where an optical wavefront is introduced, a first lens that performs a Fourier transform of an input optical field, a filtering element at a Fourier plane, which selectively attenuates or modifies specific spatial frequency components, and a second lens that reconstructs a modified optical wavefront into a filtered output. Possible implementations of this configuration of the dispersive optical element will be described below with respect to FIGS. 4-5. Further to this embodiment, the filtering element at the Fourier plane may be one of an amplitude mask, spatial light modulator, transmissive liquid crystal display, or reflective liquid crystal display.

In an embodiment, the lens 102 may be a focusing lens that focuses the light from the scene onto the dispersive optical element of the spectral filter 104. In another embodiment, the lens 102 may be a telecentric lens that changes an angle of the light focused near the dispersive optical element to be parallel to an optical axis of the reconfigurable optical filter.

In another embodiment, the spectral filter 104 may include a diffractive optical element configured to change a direction of the light per spectral band or group of spectral bands, a beam splitter configured to receive the light from the diffractive optical element, to filter a first portion of the light, and to transmit a second portion of the light, and a spatial light modulator (SLM) or a digital light processor (DLP) configured to receive the second portion of the light from the beam splitter and to transmit the wavelengths of the second portion of the light that are in a preselected subset of spectral bands. One implementation of this configuration of the spectral filter 104 will be described below with respect to FIG. 5.

The camera system 100 further includes a detector 106. The detector 106 refers to a component of the camera system 100 that is configured to receive the two or more non-contiguous narrow spectral bandwidth signals (e.g. from the spectral filter 104) for detecting wavelengths of interest. Wavelengths of interest refer to the wavelengths of the light that are within the two or more non-contiguous narrow spectral bandwidth signals transmitted by the spectral filter 104, or in other words that are within each of the above mentioned two or more defined spectral bands that the spectral filter 104 is specifically configured to transmit. In an embodiment, the spectral filter 104 may be situated in a same plane as the detector 106.

In an embodiment, the wavelengths detected at the detector 106 may form an image (i.e. of the scene from which the light was captured by the lens 102). In an embodiment, the detector 106 may be a traditional image detector or a detector which, itself, uses compressive sensing to reconstruct images. To this end, the camera system 100 may be a hyperspectral or multispectral camera system that is configured to form the image from the wavelengths of interest. This filtering may be referred to as compressive sensing as not all spectral wavelengths are detected at the detector 106 and used to form the resulting image.

Furthermore, since the camera system 100 includes the reconfigurable spectral filter 104, the wavelengths of interest may be reconfigured as desired. Thus, the camera system 100 may form different images from different spectral bands, as desired. In an embodiment, the configuration of the spectral filter 104, or namely the selection of which non-contiguous narrow spectral bandwidth signals are transmitted by the spectral filter 104, may be used to speed up the image capture by acquiring and constructing approximate spectra (i.e. spectra which are approximately correct which have been reconstructed from less than all the observable spectral bands) from a scene. Furthermore, in some embodiments (e.g. when the increased speed is not required), the spectral filter 104 may be reconfigured to transmit all spectral bands from the scene to the detector 106 for forming the full-spectrum image.

In an embodiment, the configuration of the spectral filter 104, or namely the selection of which non-contiguous narrow spectral bandwidth signals are transmitted by the spectral filter 104, may be made based on a downstream application is that is configured to process the image formed by the camera system 100. The downstream application may be configured to use certain spectral bands of an object or material, as captured in the image, to identify the object/material, to determine the physical boundaries of the object/material, or to make some other inference about the object/material. For example, the downstream application may process the image for diagnosis of malignant diseases (e.g. cancer), remote monitoring of crops and pest infestation, detection and monitoring of environmental pollutants, remote identification and surveillance of enemy fortifications, etc. In other exemplary embodiments, the downstream application may process the image for identification and tracking of objects in computer vision, including for example, in manufacturing, aiding robots in being able to determine if the humanoid shape is a human or a mannequin, or may process the image for identification of when someone is trying to fool facial recognition by wearing masks or cosmetics.

In an embodiment, the camera system 100 may further include a memory that stores a representation of an image based on the wavelengths detected at the detector 106. In an embodiment, the camera system 100 may further include a control element configured to receive a selection of non-contiguous narrow spectral bands of interest. The control element may be manipulatable by a user of the camera system 100 for inputting the selection. Of course, in another embodiment, the non-contiguous narrow spectral bands of interest may be chosen randomly.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

FIG. 2 illustrates a camera system 200 with a color filter wheel, in accordance with an embodiment. It should be noted that the aforementioned definitions and/or description may equally apply to the description below.

The illustrated camera system 200 may be considered a spectrally scanning hyperspectral or multispectral camera system. Scanning techniques relieve some of the constraints of the tradeoff between spatial and spectral resolution of non-scanning techniques by allowing one of the dimensions of a spectral data cube to be obtained serially, namely by scanning that dimension in time. Spectral scanning techniques place optical filters which only allow a subsection of the optical spectrum to arrive at the detector 106. By trading out the filters, differing spectral bands of light in the scene may be captured at the native resolution of the detector 106. One exemplary advantage that scanning techniques have over non-scanning techniques is that, for the same camera detector 106, they can capture a scene at higher spatial resolution. However, scanning techniques generally take longer to acquire a hyperspectral or multispectral image with a scanning technique than with a non-scanning technique. If something moves in the scene during the time that it takes to acquire an image, for spectrally scanning techniques, the moving object will contribute to the recorded spectra at different places in the image.

The present camera system 200 provides the ability to increase the speed of an acquiring scanning method used to obtain a hyperspectral or multispectral image, including to preserve the spatial resolution of the scanning techniques while alleviating the issues associated with the time that it takes to acquire a hyperspectral/multispectral image while scanning. In particular, obtaining the spectrally scanned hyperspectral/multispectral image may be sped up by using compressive sensing at the cost of obtaining an approximately correct (or “plausible”) spectrum rather than a rigorously correct spectrum.

As shown, the camera system 200 includes a lens 102 (e.g. focusing lens) that captures, or gathers, light from a scene. Objects in the scene (e.g. the plate, mug, and wooden coaster) scatter light from a light source (not shown). Some of the scattered light travels from the objects in the scene (lines traveling from the mug, for instance) towards the lens 102 of the camera system 200.

The lens 102 directs the light towards a detector 106 of the camera system 200. Light which corresponds to parts of the scene which are “in focus” are tightly focused on the detector 106 plane. The control electronics 204 controls the time that the detector 106 gathers light and records the scene. Typically, the strongest signals in the scene come from those areas of the scene which are in focus and the light from the rest of the scene is blurred out.

As also shown, a color filter wheel 202 is situated between the lens 102 and the detector 106. The color filter wheel 202 operates as the reconfigurable spectral filter 104 of FIG. 1. In the present embodiment, the color filter wheel 202 contains a plurality of filters which each allow a narrow and continuous bandwidth of wavelengths to reach the detector 106. The various filters in the color filter wheel 202 allow different wavelength bands of light through them. A subset of the filters of the color filter wheel 202 to be used to capture the scene may be preselected. Further, the selected filters of the color filter wheel 202 may be reconfigurable depending on the spectra to be gathered at the detector 106.

Data corresponding to different spectral bands is gathered by exposing an image of the scene with different filters of the color filter wheel 202 in line with the detector 106. In some embodiments, the user of the camera system 200 may configure the color filter wheel 202 to gather an accurate (i.e. full) spectrum rather than a plausible (i.e. partial) spectrum for each location in the image. However, this constraint slows the process of obtaining the data for the hyperspectral/multispectral data cube because data corresponding to each wavelength band must be gathered individually. This configuration may be useful in some situations where the accurate spectrum is preferred over the cost of the longer processing time.

For other situations where the reduced processing time is preferred over the accurate spectrum, such as gathering data for entertainment, the color filter wheel 202 may be configured to gather the plausible spectrum. It should be noted that the process of obtaining hyperspectral/multispectral data which has both high spatial resolution and high spectral resolution could be faster in cases in which the requirement for the spectra are that the spectra be only approximately or plausibly correct. In that case, it would be reasonable to use compressive sensing to obtain plausible spectra and increase the speed of capture of the entire hyperspectral/multispectral cube. For example, each of the filters could be configured such that they allow two or more non-continuous narrow wavelength bands to pass through to the detector. Additionally, the filter wheel may be constructed to cover all or a subset of the narrow wavelength bands and in this embodiment the full spectrum would be approximately reconstructed from the available spectral data.

With respect to the present camera system 200, multiple images are taken to gather all the information in the hyperspectral/multispectral data cube. Each image gathers spectral information from one narrow wavelength bandwidth spectral band at a time, by employing a select one of the filters. The color filter wheel 202 in front of the detector 106 insures that, at the time of exposure, only wavelengths of light in the spectral slice of interest is detected at the time of exposure.

FIG. 3 illustrates a camera system 300 with a dispersive optical element and a reconfigurable optical filter, in accordance with an embodiment. It should be noted that the aforementioned definitions and/or description may equally apply to the description below.

The camera system 300 is operated similar to the camera system 200 of FIG. 2, but instead of including the color filter wheel 202, the present camera system 300 includes a dispersive optical element 302 and a reconfigurable optical filter 304. The dispersive optical element 302 and the reconfigurable optical filter 304, in combination, operate as the reconfigurable spectral filter 104 of FIG. 1.

The dispersive optical element 302 is configured to change the direction in which light travels based on its wavelength or frequency. The dispersive optical element 302 may be a diffractive optical element, such as a diffraction grating or a holographic optical element, in embodiments, that angularly segregates the spectral information in the image. The optical filter 304 is configured to select the wavelengths transmitted based on the direction of propagation of the light. Accordingly, the optical filter 304 may choose which wavelengths of light arrive at the detector 106 based on the direction of propagation of the light at the optical filter 304.

The optical filter 304 may be referred to as a direction sensitive filter. The optical filter 304 may be built from off the shelf components, for example as described below with reference to FIG. 4.

FIG. 4 illustrates an optical filter 400, in accordance with an embodiment. It should be noted that the aforementioned definitions and/or description may equally apply to the description below.

The optical filter 400 includes two lenses 402, 406 spaced by the addition of their two focal lengths and a filtering element (e.g. mask) 404 which is placed one focal length from each lens. The filtering element 404 in between the lenses 402, 406 only allows light traveling in predetermined directions to propagate through the optics and be recorded at the location of the imaging detector 106.

There are many options for the filtering element 404. For example, a filtering element 404 comprised of a transmissive liquid crystal spatial light modulator could allow a selection of which bandwidths of wavelengths to view, and reconfiguring the camera system employing the optical filter 400 between different modes (e.g. the slow/accurate and fast/plausible modes) may be achieved by programming different filters/masks to be displayed on the spatial light modulator.

In an embodiment, the optical filter 400 may be comprised of a 4-f optical configuration used for Fourier filtering. In this implementation, light travels from left, at the input plane, to right at the output plane. Light entering the system from the input plane may be considered in groups of parallel rays. One such group of parallel rays is highlighted. At the first lens 402, which may be considered a Fourier transforming lens, those rays are focused to one position in the focal plane (labeled “Fourier Plane”) of the first lens 402. Those rays then propagate to the second lens 406, which may be considered an inverse Fourier transforming lens, where they are again collimated and travel to the output plane. Since all sets of parallel rays are focused to different positions in the Fourier plane based on their direction of propagation, placing the filtering element 404 in the Fourier plane which only allows light focused at one position to travel through the rest of the system effectively selects light based on the direction of propagation of the light.

More specifically, in this embodiment that provides directional filtering, the two lenses 402, 406 are spaced from each other by the sum of their focal lengths while the input plane is spaced to the left of the first lens 402 by its focal length and the output plane is spaced to the right of the second lens 406 by its focal length. While the name 4f comes from the configuration shown in which the focal lengths are the same, it should be noted that a similar configuration using lenses of differing focal length may also be used to magnify the spatial extent of the beam or the angles involved. In the 4-f configuration, bundles of parallel rays entering the system 400 through the input plane are focused to a common position in the Fourier plane by the first lens 402. As those rays travel through the second lens, they are transformed by the second lens 406 into a bundle of parallel rays which then travel onto the output plane. All collections of light rays traveling from the input plane to the first lens 402 may be grouped into such bundles of parallel rays and bundles which differ in direction of propagation when they leave the input plane will be focused to different positions in the Fourier plane. Placing a filtering element 404 in the Fourier plane which allows rays which pass one particular position in the Fourier plane but blocks all other positions in the Fourier plane, then allows the 4-f system to act as if it is a direction selective filter. Further, the 4-f system preserves position information from the input plane. In the case in which both focal lengths are the same, the position in the output plane is found by reflecting the position in the input plane through the optical axis of the 4f configuration. If the focal lengths are not the same there is also a scaling factor involved.

FIG. 5 illustrates a camera system 500 with the optical filter 400 of FIG. 4, in accordance with an embodiment. It should be noted that the aforementioned definitions and/or description may equally apply to the description below.

The lens 102 focuses light on the plane containing the dispersive optical element 302. The jagged lines in between the dispersive optical element 302 and the lens 102 indicate a large distance (relative to other scales in the image) between the lens 102 and the dispersive optical element 302. This large distance will be discussed further below. The present embodiment assumes that the direction of the lines in the dispersive optical element 302 are perpendicular to the plane of the figure.

Near the waist of the beams focused by the lens 102, the beams are approximately parallel. At the dispersive optical element 302, part of the beam diffracts into beams of differing wavelength and direction and part of the beam continues traveling forward. The undiffracted beams are illustrated in the sketch as a black outline (unfilled) at the boundary of the beams. Positive diffraction orders are illustrated with solid filling. Negative diffraction orders are illustrated with gray outlines (unfilled). Only two diffracted wavelengths are illustrated for clarity. The lighter gray beams have wavelengths which are smaller than the wavelengths of the darker gray beams.

In this illustrative example, because the original beam waists from the beams focused onto the dispersive optical element 302 are approximately parallel, the diffraction angles in the plane of the figure for the diffracted beams which have the same wavelength and same diffraction order are also approximately the same. Therefore, light of each diffraction order and the same wavelength are focused to the same height in the Fourier plane. A filtering element 404 set in this Fourier plane can then choose which wavelengths of light propagate through the second lens 406 to reform the image containing only those wavelengths which were not filtered out.

Regarding the distance between the between the dispersive optical element 302 and the lens 102, the illustration in FIG. 4 assumes that the camera lens 102 is located much farther away from the dispersive optical element 302 than the lateral extent of the dispersive optical element 302 that is effectively used in the design of the camera system. In that case, the waists of the beams of light which are in focus at the position of the dispersive optical element 302 are approximately parallel. As a result, the diffracted light from each, in focus, position will also be similar. In FIG. 5 two such beams are considered. As each beam interacts with the dispersive optical element 302, a small fraction of the beam continues forward in the same direction that it impinged on the diffraction grating. On the other hand, for the light which does diffract, the longest wavelengths diffract to the widest angles and the shortest wavelengths diffract the least. Depending on the design of the dispersive optical element 302 the positive and negative orders of diffraction may have equal intensity or the positive and negative diffraction orders may have very different intensity.

To choose which wavelengths of light make it to the camera detector 106 and form an image there, the filtering element 404 is placed in the Fourier plane which blocks all unwanted wavelengths. Depending on design choices, the camera system 500 could allow only the positive diffraction orders of desired wavelengths to pass the Fourier plane, only the negative orders of the desired wavelengths to pass the Fourier plane or allow both the positive and negative diffraction orders of the desired wavelengths to pass the Fourier plane. Choices of whether or not to allow positive or negative orders to pass the Fourier plane could be based on the intensity of light which finally makes it to the camera detector 106, the ability to discriminate between closely spaced groupings of wavelengths or removing ambiguities in compressive sensing techniques.

This design allows the user of the camera system 500 to change configurations between carefully and slowly building up the spectrum measured at each pixel to quickly and approximately measuring the spectrum of each of the pixels. To measure the spectrum of each of the pixels slowly and carefully, only the positive and/or negative diffraction orders for one narrow bandwidth set of wavelengths is allowed to pass through the Fourier Plane at a time and one image is captured when the appropriate mask is placed in the Fourier plane. This mask could be something which is solid and permanent like a rotating disk with appropriate holes cut into it or something which is reconfigurable like a transmissive liquid crystal display with small pixels. Allowing two or more distinct sets of wavelengths to pass through the Fourier plane the configuration of the mask in the Fourier plane is changed to include two or more “holes”. If the mask in the Fourier plane is reconfigurable, which for example may be possible with the transmissive liquid crystal display, then, with an appropriate user interface, the user would be able to choose between the slow and fast approaches.

In the cases in which the camera system 500 is built such that the camera lens is not far from the dispersive optical element 302 when compared to a length scale characterizing the effective, useful area of the dispersive optical element 302, the direction of travel of light in the waists of each of the beams which come into focus at the location of the dispersive optical element 302 may not be approximately parallel. In those cases, the angle at which the waist impinges on the dispersive optical element 302 will change the angle at which light of different wavelengths diffracts from the dispersive optical element 302. While the same schemes for acquiring per pixel spectra may be applied, the interpretation of the wavelengths of light detected at the camera detector 106 must be changed to incorporate information about the distance of the lens 102 from the dispersive optical element 302, the positions in the Fourier plane which allow light to pass, and the position on the detector 106 at which light was detected. In the limit of paraxial optics, the relationship between the height on the detector 106, y, the focal length used in the 4-f system, f, the distance between the camera lens 102 and the dispersive optical element 302, d, the height in the Fourier plane at which light is allowed to pass, yₘ, the line pitch of the dispersive optical element 302, g, the diffraction order, m, and the central wavelength of light allowed to pass through the mask in the Fourier plane, λ, may be found by starting with the equation for the case in which light is incident on the dispersive optical element 302 at angle θᵢ and diffracts at angle θ^{D}:

$$sin ( {θ}^{D} ) - sin ( {θ}_{i} ) = \frac{m λ}{g}$$

Noting that choosing the position, yₘ, at which light is allowed to pass chooses the diffraction angle, OD, one can substitute system variables for the sines of both angles and solve for the central wavelength of the narrow bandwidth of wavelengths allowed through the mask at the Fourier plane:

$$λ - \frac{g}{m} ( \frac{{y}_{m}}{\sqrt{{y}_{m}^{2} + {f}^{2}}} + \frac{y}{\sqrt{{y}^{2} + {d}^{2}}} )$$

In the case in which the paraxial optics is not appropriate (thick or short focal length optics), more complicated models of the optics, numerical modes of the optics, or explicit calibration would achieve a mapping between the position on the camera detector 106, the position and shape of the area in the Fourier plane in which light was allowed to pass and the wavelengths of light which would be detected at the position of the detector 106.

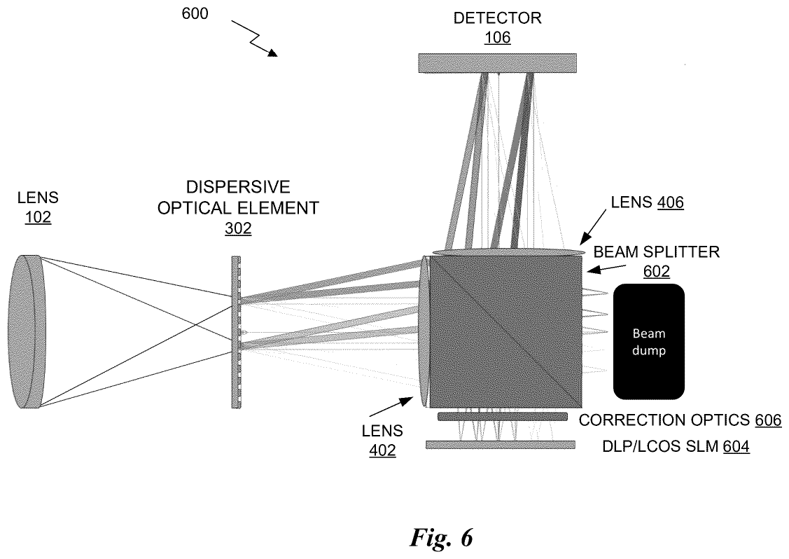

FIG. 6 illustrates a camera system 600 with a folded optical path including the optical filter 400 of FIG. 4, in accordance with an embodiment.

Conceptually, the operation of the camera system 600 is the same as the configuration of the camera system 500 in FIG. 5. In the present embodiment, however, a beam splitter 602 sends part of the light to a beam dump (where it is lost) and the rest the beam splitter 602 redirects to reflective element 604 which acts as the filtering element 404 in the Fourier plane. As shown, the reflective element 604 may be a SLM or a DLP. The reflective element 604 reflects light back towards the camera detector 106 where it is detected similarly to the arrangement in FIG. 5.

### Additional Embodiment—Denoising

Unless a camera system is capturing an image of noise, images captured with a camera system such as those described above are not collections of random pixel intensities. The correlations between nearby pixel values help create meaning in images for human observers and removal of the “random” part of an image generally improves image quality. The same is true for images even when they are limited to a restricted part of the visible spectrum, which may be captured using any of the camera systems described above.

This means that either traditional or machine learned methods are possible for denoising images. Since decreasing the capture time of an image with a camera detector is generally associated with increasing the relative ratio of noise to signal, it's possible to decrease the exposure time to record the data corresponding to a particular narrow bandwidth of wavelengths (or a group of two or more narrow bandwidth “slots”) and to denoise the image after it has been acquired. This decreases the time it takes to acquire the data corresponding to a complete hyperspectral/multispectral data cube. Many denoising or regularization algorithms from either traditional computer vision or artificial intelligence may be appropriate. For a specific example, one technique may include, during the sparce matrix reconstruction of compressive images, either the magnitude of the gradient in adjacent pixel values may be minimized or the curvature in pixel values may be minimized.

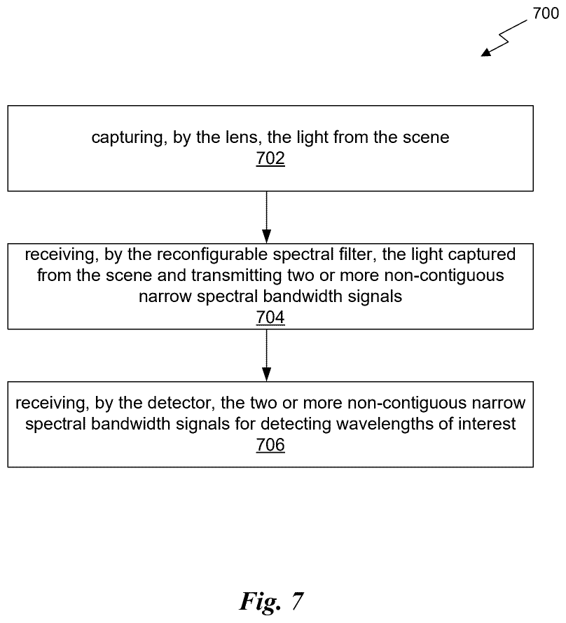

FIG. 7 illustrates a method 700 of operation of a hyperspectral or multispectral camera system, in accordance with an embodiment. In the present embodiment, the method 700 is carried out using the implementation of the camera system 100 of FIG. 1, namely that includes a lens configured to capture light from a scene, a reconfigurable spectral filter configured to receive the light captured from the scene and to transmit two or more non-contiguous narrow spectral bandwidth signals, and a detector configured to receive the two or more non-contiguous narrow spectral bandwidth signals for detecting wavelengths of interest.

In operation 702, light from the scene is captured by the lens. In operation 704, the light captured from the scene is received by the reconfigurable spectral filter and two or more non-contiguous narrow spectral bandwidth signals are transmitted. In operation 706, the two or more non-contiguous narrow spectral bandwidth signals are received by the detector for detecting wavelengths of interest.

In an embodiment, the spectral filter may include a dispersive optical element configured to change a direction in which the light captured from the scene travels based on its wavelength or frequency, and a reconfigurable optical filter configured to select wavelengths transmitted based on the changed direction of the light.

In an embodiment, the lens may be one of a focusing lens that focuses the light from the scene onto the dispersive optical element, or a telecentric lens that changes an angle of the light focused near the dispersive optical element to be parallel to an optical axis of the reconfigurable optical filter.

In an embodiment, the dispersive optical element may be a diffractive optical element, which for example may be one of a diffraction grating or a holographic element.

In an embodiment, the optical filter may be one of: a rotating filter, or a spatial optical filter consisting of at least: an input plane at a location of the dispersive optical element where an optical wavefront is introduced, a first lens that performs a Fourier transform of an input optical field, a filtering element at a Fourier plane, which selectively attenuates or modifies specific spatial frequency components, and a second lens that reconstructs a modified optical wavefront into a filtered output.

In an embodiment, the reconfigurable spectral filter may include a color filter wheel comprised of a plurality of filters each configured to transmit wavelengths for one or more different spectral bands. In an embodiment, the spectral filter may include a diffractive optical element configured to change a direction of the light per spectral band or group of spectral bands, a beam splitter configured to receive the light from the diffractive optical element, to filter a first portion of the light, and to transmit a second portion of the light, and a SLM or a DLP configured to receive the second portion of the light from the beam splitter and to transmit the wavelengths of the second portion of the light that are in a preselected subset of spectral bands.

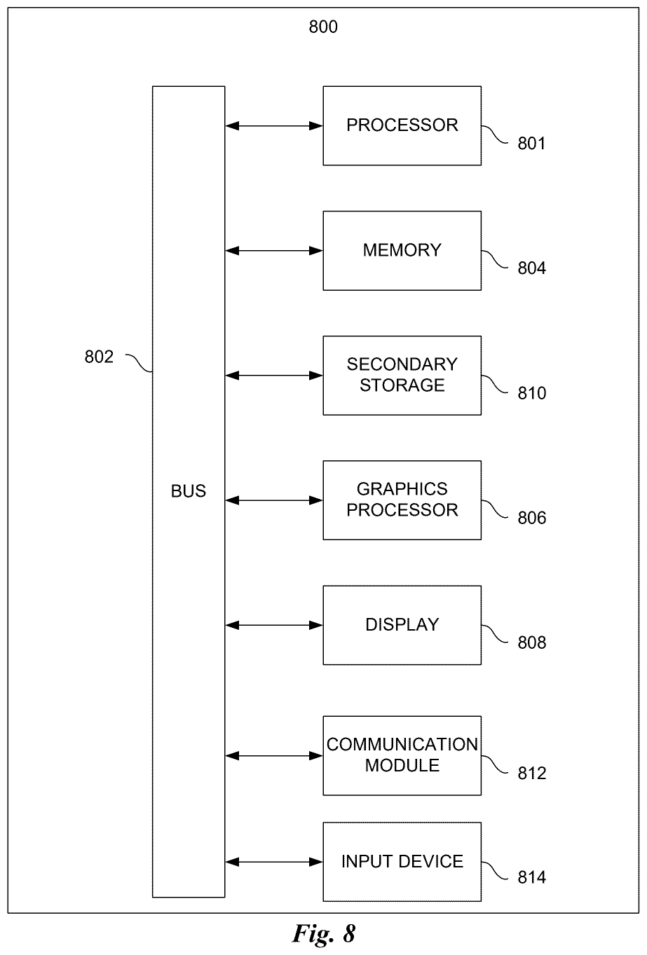

In an embodiment, wavelengths detected at the detector may form an image. In an embodiment, the method 700 may further include storing in memory a representation of an image based on the wavelengths detected at the detector. The memory may be any of the memory components described below with respect to FIG. 8, for example. In an embodiment, the method 700 may further include receiving at a control element a selection of non-contiguous narrow spectral bands of interest, for example where the selection is received from a user. In another embodiment, the non-contiguous narrow spectral bands of interest may be chosen randomly.

FIG. 8 illustrates an exemplary computing system 800, in accordance with an embodiment. The camera system of the method 700 of FIG. 7 (not shown), or the camera system 100 of FIG. 1 or of any other embodiment described above (also not shown), may be in communication with the system 800 to receive output of the system 800 and/or to provide input to the system 800. Just by way of example, the camera system may receive from the system 800 control signals that select which non-contiguous narrow spectral bands of interest are to be used for generating an image. As another example, the image formed at the detector of the camera system may be output to the system 800 (e.g. for storage, display, further processing such as denoising or processing by a downstream application, etc.).

The camera system and the system 800 may be located in the same environment, or remotely (e.g. the system 800 may be located in the cloud). It should be noted that the camera system may communicate with the system 800 via a wired connection or a wireless network connection (e.g. WiFi, cellular network etc.). As an option, one or more of the components shown in system 800 may be implemented within the camera system.

As shown, the system 800 includes at least one central processor 801 which is connected to a communication bus 802. The system 800 also includes main memory 804 [e.g. random access memory (RAM), etc.]. The system 800 also includes a graphics processor 806 and a display 808.

The system 800 may also include a secondary storage 810. The secondary storage 810 includes, for example, a hard disk drive and/or a removable storage drive, representing a floppy disk drive, a magnetic tape drive, a compact disk drive, a flash drive or other flash storage, etc. The removable storage drive reads from and/or writes to a removable storage unit in a well-known manner.

Computer programs, or computer control logic algorithms, may be stored in the main memory 804, the secondary storage 810, and/or any other memory, for that matter. Such computer programs, when executed, enable the system 800 to perform various functions, including for example configuration of the camera system as set forth above. Memory 804, storage 810 and/or any other storage are possible examples of non-transitory computer-readable media.

The system 800 may also include one or more communication modules 812. The communication module 812 may be operable to facilitate communication between the system 800 and one or more networks, and/or with one or more devices (e.g. game consoles, personal computers, servers etc.) through a variety of possible standard or proprietary wired or wireless communication protocols (e.g. via Bluetooth, Near Field Communication (NFC), Cellular communication, etc.).

As also shown, the system 800 may include one or more input devices 814. The input devices 814 may be a wired or wireless input device. In various embodiments, each input device 814 may include a keyboard, touch pad, touch screen, game controller, remote controller, or any other device capable of being used by a user to provide input to the system 800.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A camera system, comprising:
a lens configured to capture light from a scene;
a reconfigurable spectral filter configured to receive the light captured from the scene and to transmit two or more non-contiguous narrow spectral bandwidth signals; and
a detector configured to receive the two or more non-contiguous narrow spectral bandwidth signals for detecting wavelengths of interest.

2. The camera system of claim 1, wherein the spectral filter includes:
a dispersive optical element configured to change a direction in which the light captured from the scene travels based on its wavelength or frequency, and
a reconfigurable optical filter configured to select wavelengths transmitted based on the changed direction of the light.

3. The camera system of claim 2, wherein the lens is a focusing lens that focuses the light from the scene onto the dispersive optical element.

4. The camera system of claim 2, wherein the lens is a telecentric lens that changes an angle of the light focused near the dispersive optical element to be parallel to an optical axis of the reconfigurable optical filter.

5. The camera system of claim 2, wherein the dispersive optical element is a diffractive optical element.

6. The camera system of claim 5, wherein the diffractive optical element is a diffraction grating.

7. The camera system of claim 5, wherein the diffractive optical element is a holographic element.

8. The camera system of claim 2, wherein the optical filter is a rotating filter.

9. The camera system of claim 2, wherein the optical filter is a spatial optical filter consisting of at least:
an input plane at a location of the dispersive optical element where an optical wavefront is introduced,
a first lens that performs a Fourier transform of an input optical field,
a filtering element at a Fourier plane, which selectively attenuates or modifies specific spatial frequency components, and
a second lens that reconstructs a modified optical wavefront into a filtered output.

10. The camera system of claim 9, wherein the filtering element at the Fourier plane is one of an amplitude mask, spatial light modulator, transmissive liquid crystal display, or reflective liquid crystal display.

11. The camera system of claim 1, wherein the spectral filter includes:
a color filter wheel comprised of a plurality of filters each configured to transmit wavelengths for one or more different spectral bands.

12. The camera system of claim 1, wherein the reconfigurable spectral filter is situated in a same plane as the detector.

13. The camera system of claim 2, wherein the spectral filter includes:
a diffractive optical element configured to change a direction of the light per spectral band or group of spectral bands,
a beam splitter configured to receive the light from the diffractive optical element, to filter a first portion of the light, and to transmit a second portion of the light, and
a spatial light modulator (SLM) or a digital light processor (DLP) configured to receive the second portion of the light from the beam splitter and to transmit the wavelengths of the second portion of the light that are in a preselected subset of spectral bands.

14. The camera system of claim 1, wherein the wavelengths detected at the detector form an image.

15. The camera system of claim 1, further comprising:
a memory that stores a representation of an image based on the wavelengths detected at the detector.

16. The camera system of claim 1, further comprising:
a control element configured to receive a selection of non-contiguous narrow spectral bands of interest.

17. The camera system of claim 16, wherein the control element is manipulatable by a user of the camera system for inputting the selection.

18. The camera system of claim 1, wherein the non-contiguous narrow spectral bands of interest are chosen randomly.

19. A method, comprising:
at a camera system comprised of a lens configured to capture light from a scene, a reconfigurable spectral filter configured to receive the light captured from the scene and to transmit two or more non-contiguous narrow spectral bandwidth signals, and a detector configured to receive the two or more non-contiguous narrow spectral bandwidth signals for detecting wavelengths of interest:
capturing, by the lens, the light from the scene;
receiving, by the reconfigurable spectral filter, the light captured from the scene and transmitting two or more non-contiguous narrow spectral bandwidth signals; and
receiving, by the detector, the two or more non-contiguous narrow spectral bandwidth signals for detecting wavelengths of interest.

20. The method of claim 19, wherein the spectral filter includes:
a dispersive optical element configured to change a direction in which the light captured from the scene travels based on its wavelength or frequency, and
a reconfigurable optical filter configured to select wavelengths transmitted based on the changed direction of the light.

21. The method of claim 20, wherein the lens is one of:
a focusing lens that focuses the light from the scene onto the dispersive optical element, or
a telecentric lens that changes an angle of the light focused near the dispersive optical element to be parallel to an optical axis of the reconfigurable optical filter.

22. The method of claim 20, wherein the dispersive optical element is a diffractive optical element.

23. The method of claim 22, wherein the diffractive optical element is one of:
a diffraction grating, or
a holographic element.

24. The method of claim 20, wherein the optical filter is one of:
a rotating filter, or
a spatial optical filter consisting of at least:
an input plane at a location of the dispersive optical element where an optical wavefront is introduced,
a first lens that performs a Fourier transform of an input optical field,
a filtering element at a Fourier plane, which selectively attenuates or modifies specific spatial frequency components, and
a second lens that reconstructs a modified optical wavefront into a filtered output.

25. The method of claim 19, wherein the spectral filter includes:
a color filter wheel comprised of a plurality of filters each configured to transmit wavelengths for one or more different spectral bands.

26. The method of claim 20, wherein the spectral filter includes:
a diffractive optical element configured to change a direction of the light per spectral band or group of spectral bands,
a beam splitter configured to receive the light from the diffractive optical element, to filter a first portion of the light, and to transmit a second portion of the light, and
a spatial light modulator (SLM) or a digital light processor (DLP) configured to receive the second portion of the light from the beam splitter and to transmit the wavelengths of the second portion of the light that are in a preselected subset of spectral bands.

27. The method of claim 19, wherein the wavelengths detected at the detector form an image.

28. The method of claim 19, further comprising:
storing in memory a representation of an image based on the wavelengths detected at the detector.

29. The method of claim 19, further comprising:
receiving at a control element a selection of non-contiguous narrow spectral bands of interest.

30. The method system of claim 29, wherein the selection is received from a user.

31. The method of claim 19, wherein the non-contiguous narrow spectral bands of interest are chosen randomly.
